(19) United States
(12) Patent Application Publication
(10) Pub. No.: US 2024/0239575 A1
(43) Pub. Date: Jul. 18, 2024

(54) LOCK STRUCTURE FOR SECURING CAP OF TUBE

(71) Applicant: Uh-Oh Labs Inc., Santa Clara, CA (US)

(72) Inventors: Cameron Scott Ball, Sunnyvale, CA (US); Alex Jiao, Seattle, WA (US)

(21) Appl. No.: 18/097,798

(22) Filed: Jan. 17, 2023

(51) Int. Cl. B65D 55/02

(52) U.S. Cl. CPC B65D 55/024

(57) ABSTRACT

A device for securing a cap of a container. The device may include a bottom plate and a top plate. The bottom plate may be formed with a side opening open towards a side of the device to receive in the cap of the container closing an open end of the container, and a center opening connected to the side opening. The center opening may be dimensioned to receive the cap of the container and have a width larger than a width of a portion of the side opening. The side opening and the center opening may define a pair of inward protrusions to capture the cap of the container. The top plate may be spaced away from the bottom plate and configured to at least partially cover the cap of the container.

### FILED OF ART

This disclosure relates generally to a device for securing a cap of a container and more particularly to a cap lock for securing a cap of a container.

### BACKGROUND

The risk of amplicon contamination resulting from a user opening an assay tube containing an amplified product is of FDA's expressed concerns. One of existing methods for mitigating such risk includes using a winged sticker that attaches to the top of the assay tube. The winged sticker wraps around the lid's front and sides, providing added closure security to the snap cap for testing. The winged sticker is applied by the user as the last physical step before running a test and can be used to indicate that the tube has been used. However, such mitigation measure still leaves the risk that the user may re-open the assay tube after closing the lid. Therefore, a measure that can further mitigate against the risk of re-opening and contaminating or infecting the user is preferred.

### SUMMARY

Embodiments relate to a device for securing a cap of a container. The device may include a bottom plate and a top plate. The bottom plate may be formed with a side opening open towards a side of the device to slide in the cap of the container closing an open end of the container, and a center opening connected to the side opening. The center opening may be dimensioned to receive the cap of the container and have a width larger than a width of a portion of the side opening. The side opening and the center opening may define a pair of inward protrusions to capture the cap of the container after the cap is slid in through the side opening. The top plate may be spaced away from the bottom plate and configured to at least partially cover the cap of the container.

### BRIEF DESCRIPTION OF THE DRAWINGS

FIG. 1 illustrates a bottom view of a cap lock for securing a cap of a container, according to one or more embodiments.

FIG. 2 illustrates a perspective view of a cap lock for securing a cap of a container, according to one or more embodiments.

FIG. 3 illustrates a perspective view of a cap lock installed on the cap of a container, according to one or more embodiments.

FIG. 4 is a flowchart illustrating a process for using a cap lock for securing a cap of a container, according to one or more embodiments.

### DETAILED DESCRIPTION

The figures and the following description describe certain embodiments by way of illustration only. One skilled in the art will readily recognize from the following description that alternative embodiments of the structures and methods may be employed without departing from the principles described. Reference will now be made to several embodiments, examples of which are illustrated in the accompanying figures. Wherever practicable similar or like reference numbers are used in the figures to indicate similar or like functionality. Where elements share a common numeral followed by a different letter, the elements are similar or identical. The numeral alone refers to any one or any combination of such elements.

Embodiments relate to a device for securing a cap of a container. The device may include certain geometry and mechanical features to ensure that the cap stays fixed on top of the container after the device is installed. The device functions as a cap lock that locks the cap, and may include a side opening and inward protrusions. The side opening permits easy installation of the device while the inward protrusions prevent removal of the device from the cap after installation. The device may further include uncomfortable but harmless bumps on the side of the device to discourage attempts to remove the device after it is installed onto the cap.

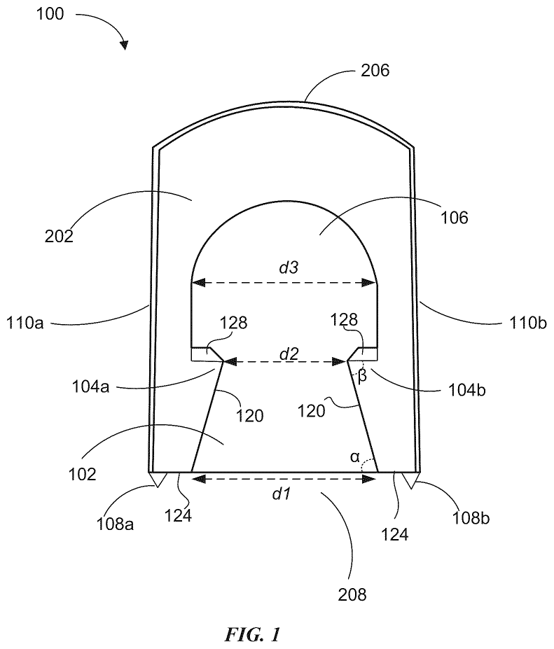

FIG. 1 illustrates a bottom view of a cap lock 100 for securing a cap 322 of a container 324, according to one or more embodiments. Various risks are associated with the re-opening of assay tubes. These risks include 1) amplicon contamination, 2) loss of fluids/spilling/evaporation, and 3) access to the fluids. The risk of contamination could result in inaccurate tests subsequent to contamination. The loss of fluids/spilling/evaporation risk the possibility of the test not running properly due to lack of adequate fluid being included in the tubes. The exposure to fluid itself may also present risk, especially if the fluid is toxic. To mitigate these risks, the cap lock 100 locks the cap to prevent re-opening of the cap 322 after the cap lock 100 is installed onto the cap 322 of the container 324.

The cap lock 100 includes a bottom plate 202 and a top plate 204. The bottom plate 202 may be formed with a side opening 102, a pair of inward protrusions 104a, 104b (collectively referred to as “inward protrusions 104” hereinafter), and a center opening 106. The top plate 204 may be spaced away from the bottom plate 202 and at least partially cover the bottom plate 202. The top plate 204 and the bottom plate 202 may be parallel to each other.

The side opening 102 of the cap lock 100 receives the cap 322 of the container 324. Once the cap 322 slides through the side opening 102 and fits into the center opening 106, the inward protrusions 104 prevents the cap 322 from being removed from the cap lock 100. In this way, the cap lock 100 secures the cap 322 of the container 324 and prevents the cap 322 from opening to mitigate leakage and contamination risks of the fluid in the container 324.

The side opening 102 is connected to an open rear end 208 of the cap lock 100 and opens towards a rear side of the cap lock 100. The cap 322 may enter from an open rear end 208 of the cap lock 100 and slide through the side opening 102 to reach the center opening 106 of the cap lock 100. The width of the side opening 102 tapers toward the center opening 106 of the cap lock 100 such that the side opening 102 has a wedged opening. The wedged opening of the side opening 102 has a wider end connecting to the open rear end 208 of the cap lock 100 and a narrower end connecting to the center opening 106. The wider end has a width of d1, the narrower end has a width of d2 where d1>d2. In some embodiments, the wider end width d1 may vary depending on the size of the cap lock 100; and the narrower end width d2 may range from 6.00-8.00 mm, for example. The side opening 102 may be defined by a wall 120 forming an angle α relative to a rear surface 124. In some examples, the angle α may range from 60 to 90 degrees. The angle α may be associated with the force for installing the cap lock 100 onto the cap 322 of the container 324. That is, increasing the angle α decreases the force for installing the cap 100 onto the cap 322 of the container 324 while decreasing the angle α increases the force for installing the cap 100.

The center opening 106 receives the cap 322 of the container 324. The dimension of the center opening 106, therefore, is large enough to accommodate the cap 322 but small enough to block the cap 322 of the container 324 from removal without excessive force. In some embodiments, the center opening 106 may be dimensioned to receive the cap 322 of the container 324 that is slid in through the side opening 102. The widest portion of the center opening 106 may have a width of d3. The width d3 may vary depending on the size of the cap 322, that may range, for example, from 5.00 mm to 15.00 mm. The width d3 may be larger than the width d2 of the narrower end of the side opening 102. In some embodiments, a portion of the center opening 106 may have a semi-circular shape, and the width d3 may be expressed as the diameter of a semi-circle. A vertical distance between the center of the center opening 106 to the inward protrusions 104 may also vary, for example, from 2.00 mm to 7.50 mm. In some embodiments, the dimension of the center opening 106 allows the bottom plate 202 to overlap with a circumferential rib on the locked container 324 to prevent the cap 322 from opening. Alternatively, the center opening 106 may be in other shapes, for example, an elliptic shape, a polygon shape, etc.

Inward protrusions 104 are provided between the side opening 102 and the center opening 106. Each of the inward protrusions 104 may consist of a portion of the wall 120, a front facing wall 128, side wall 212 and an upper facing wall (not shown) at opposite side of the front facing wall 128. The side wall 212 may adjust the distance between the front facing wall 128, and the side wall 212 and the semicircular section of the center opening 106 may match the diameter of the cap 322 and/or container 324. This prevents a wiggle or the other movements of the cap 322 and/or container 324. In some embodiments, the inward protrusions 104 may not include the side wall 212, and front facing wall 128 and the wall 120 come to a point. The center opening 106 and the side opening 102 may define the pair of inward protrusions 104 to capture the cap 322 of the container 324 after the cap 322 of the container 324 is slid in through the side opening 102. After the installation of the cap lock 100 onto the cap 322 of the container 324, the cap 322 is held by the cap lock 100 and restrained inside the center opening 106 by the inward protrusions 104. The inward protrusions 104 may be integrated with the walls 120 that define the side opening 102, and coupled with the narrower end of the side opening 102. In some embodiments, an angle ß of the inward protrusions 104 defined between the wall 120 and the front facing wall 128 may be the same as angle α

In some embodiments, the cap lock 100 may further include two side plates 110a and 110b (collectively referred to as “side plates 110” hereinafter). The side plates 110 connect the top plate 204 and the bottom plate 202. In some examples, one or more protruding bumps 108 may be located at the rear ends of the side plates 110, facing away from the center opening 106.

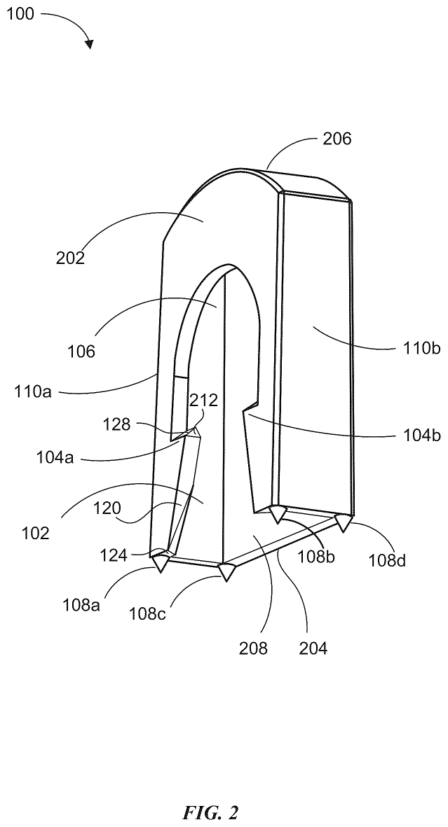

In some embodiments, the cap lock 100 may include a plurality of protruding bumps 108a, 108b, 108c, and 108d (collectively referred to as “protruding bumps 108” hereinafter) located at the open rear end 208 of the cap lock 100. The protruding bumps 108 may have sharp tips. Alternatively, the tips of the protruding bumps 108 may be rounded and have smooth and curved surfaces. The protruding bumps 108 may provide an uncomfortable touch to a user when the user presses the protruding bumps 108 with the user's finger. Thus, the protruding bumps 108 may function as non-harmful deterrents to the removal of the cap lock 100 by pushing the rear end 208 of the cap lock 100. In some embodiments, the cap lock 100 may include fewer or more protruding bumps 108 that what is illustrated in FIG. 2; and in some other embodiments, the cap lock 100 may not include any protruding bumps 108.

FIG. 2 illustrates a perspective view of the cap lock 100 for securing the cap 322 of the container 324, according to one or more embodiments. The cap lock 100 may include two side plates 110. When the cap lock 100 is installed on a cap, the top plate 204 may be configured to at least partially cover the cap of the container. The top plate 204 may have a closed surface; alternatively, the top plate 204 may include an opening. In some embodiment, the top plate 204 may include an opening with a lid that can be opened to access the cap 322 even after the cap lock 100 is installed. The bottom plate 202 and the top plate 204 may be spaced away and define a space within the cap lock 100 to accommodate the cap 322 of the container 324.

In some embodiments, the cap lock 100 may further include a front end 206 at an opposite side of the rear end 208. The front end 206 may be closed to prevent the cap 322 from sliding out of the cap lock 100. In some embodiments, the front end 206 may have a middle section that protrudes away from the center opening 106, that is, the front end 206 is reverse U-shaped. The rear end 208 is open and is connected to the wider end of the side opening 102. To install the cap lock 100 onto the cap 322 of the container 324, a relative movement may be made between the cap lock 100 and the cap 322 on the container 324 so that the cap 322 slides through the side opening 102, arrive at the center opening 106, and be clipped and held by the inward protrusions 104.

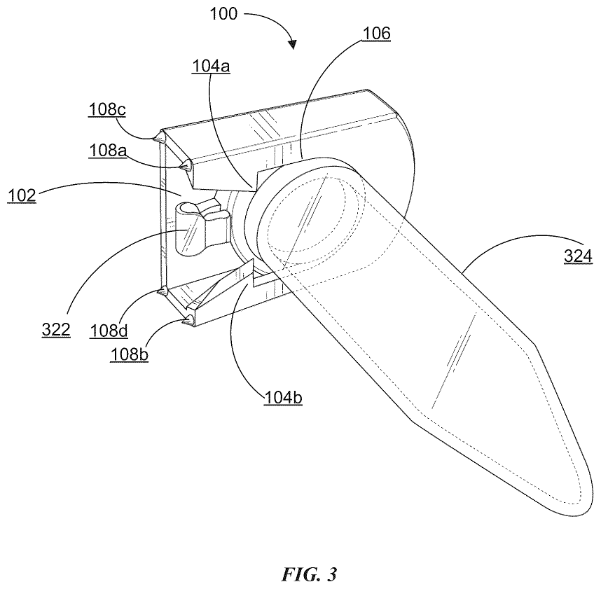

FIG. 3 illustrates another perspective view of the cap lock 100 installed on the cap 322 of the container 324, according to one or more embodiments. A relative movement is made between the cap lock 100 and the container 324 with the cap 322 so that the cap 322 and the top portion of the container 324 is pushed through the side opening 102 from its wider end to its narrower end. During the installation, the distance between the inward protrusions 104 may increase, elastically deforming the side plates 110 and the top plate 204 along with the bottom plate 202. Once installed, the side opening 102 and the inward protrusions 104 then secures the cap lock 100 to the cap 322 of the container 324 and remains secured unless excessive force is exerted to remove the cap lock 100. Because the inward protrusions 104 grabs the cap 322 and/or the top portion of the container 324, removal of the cap lock 100 involves breaking of the inward protrusions 104 or applying of greater force than the force used for installing the cap lock 100. Additionally, the geometry of the bottom plate 202 also secures the cap 322 by engaging the bottom plate 202 with the features of cap 322 and/or the container 324 to prevent the cap 322 from being opened by rotating the cap 322 around the hinge.

In some embodiments, the cap lock 100 may generate a “clicking” sound when the cap 322 slides into the center opening 106 and the cap lock 100 holds the cap 322 in the right position. Such a “clicking” sound may be an audible indication that the cap lock 100 is installed properly. In some examples, the cap 322 may be a hinged cap, or a cap with asymmetric shape. The cap lock 100 may be installed from the hinge's direction, or opposite to the hinge's direction, or any other direction, and still be able to securely hold the cap 322 to the container 324 properly. The cap lock 100 may be used for securing a cap for any kind of container, such as tubes, vials, etc. The shape and dimensions of the cap lock 100 may be modified according to the specific container. The cap lock 100 may be made from polypropylene by injection molding. Alternatively, the cap lock 100 may be fabricated using any suitable manufacturing technique.

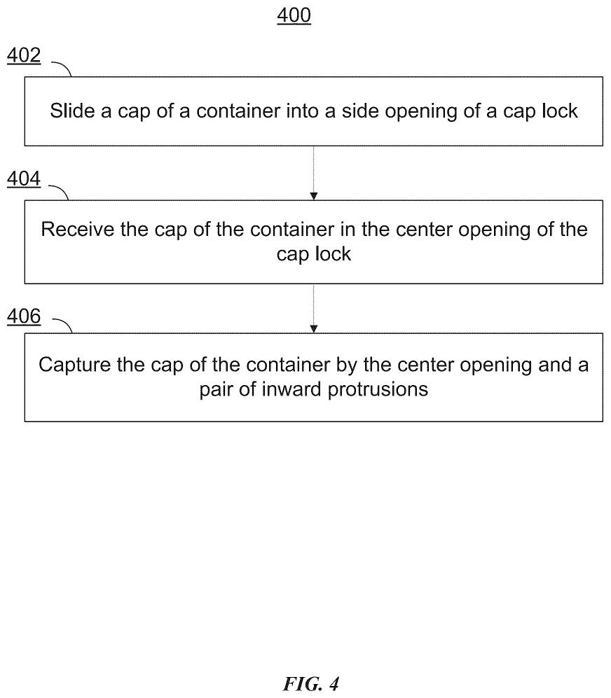

FIG. 4 is a flowchart illustrating a process 400 for using a cap lock 100 for securing a cap 322 of a container 324, according to one or more example embodiments. The cap lock 100 described herein can be used to secure a cap 322 of a container 324 such that the cap 322 closes the container's open end. During installation, a user may place a cap 322 of a container 324 at the rear end 208 of the cap lock 100 and slide 402 the cap 322 of the container 324 into a side opening 102 of a bottom plate 202 of the cap lock 100. The cap 322 slides through the side opening 102, and the cap lock 100 receives 404 the cap 322 of the container 324 in the center opening 106 of the bottom plate 202. The center opening 106 and the inward protrusions 104 may then capture 406 the cap 322 of the container 324, preventing the cap 322 from removal from the cap lock 100. In some embodiments, a successful installation of the cap lock 100 on the cap 322 may generate a clicking sound as an audio indication.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A device for securing a cap of a container, comprising:
a bottom plate formed with:
a side opening open towards a side of the device to receive in the cap of the container closing an open end of the container, and
a center opening connected to the side opening, the center opening dimensioned to receive the cap of the container, the center opening having a width larger than a width of a portion of the side opening connected to the center opening to define a pair of inward protrusions to capture the cap of the container; and
a top plate spaced away from the bottom plate and configured to at least partially cover the cap of the container.

2. The device of claim 1, wherein the width of the portion of the side opening connected to the center opening is smaller than a width of an opposite end of the side opening, the opposite end of the side opening located further away from the center opening than the portion of the side opening connected to the center opening.

3. The device of claim 2, further comprising two side plates connecting the top plate and the bottom plate, the side plates comprising one or more protruding bumps at ends facing away from the center opening.

4. The device of claim 2, further comprising a front end between the top plate and the bottom plate at a side opposite to the open end, the front end having a middle section that protrudes away from the center opening.

5. The device of claim 1, wherein the top plate has a closed surface.

6. The device of claim 1, wherein the top plate includes an openable lid.

7. The device of claim 1, wherein the width of the center opening ranges from 5 mm to 15 mm.

8. The device of claim 1, wherein the side opening includes an angle ranging from 60 to 90 degrees.

9. The device of claim 1, wherein the width of the portion of the side opening connected to the center opening ranges from 6 mm to 8 mm.

10. The device of claim 1, wherein the device is made of polypropylene.

11. A method for using a device for securing a cap of a container, comprising:
sliding the cap of the container into a side opening of a bottom plate of the device with the cap closing an open end of the container;
receiving, in a center opening of the bottom plate, the cap of the container that is slid in through the side opening; and
capturing the cap of the container by the center opening and a pair of inward protrusions defined by the center opening and the side opening, wherein a width of the center opening larger than a width of a portion of the side opening that is connected to the center opening.

12. The method of claim 11, further comprising generating a sound by the device indicating installation of the device on the cap.

13. The method of claim 11, wherein the width of the portion of the side opening connected to the center opening is smaller than a width of an opposite end of the side opening, the opposite end of the side opening located further away from the center opening than the portion of the side opening connected to the center opening.

14. The method of claim 11, wherein the device further comprises a top plate spaced away from the bottom plate and configured to at least partially cover the cap of the container.

15. The method of claim 14, wherein the device further comprises two side plates connecting the top plate and the bottom plate, the side plates comprising one or more protruding bumps at ends facing away from the center opening.

16. The method of claim 14, wherein the device further comprises a front end between the top plate and the bottom plate at a side opposite to the open end, the front end having a middle section that protrudes away from the center opening.

17. The method of claim 14, wherein the top plate has a closed surface.

18. The method of claim 14, wherein the top plate includes an openable lid.

19. The method of claim 11, wherein the device is made of polypropylene.

20. The method of claim 11, wherein the side opening includes an angle ranging from 60 to 90 degrees.
